(19) United States
(12) Patent Application Publication
(10) Pub. No.: US 2004/0218590 A1
(43) Pub. Date: Nov. 4, 2004

(54) Telecommunication network with layered switching fabric

(76) Inventors: Edward Alan Clark, Sugar Grove, IL (US); Richard Thomas Emery, Aurora, IL (US); Joseph John Kott, Aurora, IL (US); Donald T. McBride, Naperville, IL (US)

Correspondence Address: PATTI & BRILL, ONE NORTH LASALLE STREET, 44TH FLOOR, CHICAGO, IL, 60602, US

(21) Appl. No.: 10/427,424

(22) Filed: Apr. 30, 2003

(51) Int. Cl. H04L 12/50

(52) U.S. Cl. 370/357

(57) ABSTRACT

A telecommunication system includes edge switches and a transmission system that interconnects the edge switches. The transmission system includes a plurality of layered transmission networks. Communication channels connect each edge switch to at least a first of the layered transmission networks. Further, a method provides traffic routing in a telecommunication system having ordered, layered transmission networks, the originating and terminating edge switches to carry a new requested traffic are identified. The highest order layered transmission network connecting the originating and terminating edge switches that is available to carry the traffic is determined. The determined highest order layered transmission network to carry the traffic is assigned to carry the traffic.

### BACKGROUND

This invention generally relates to telecommunication systems having a plurality of edge elements, e.g. switches, and more specifically relates to how the edge switches are interconnected with transmission networks that provide the fabric across which communications are coupled from one edge switch to another. It also pertains to the internal networks of the switching fabric within a switching system itself, spanning the switching system as an individual network element.

The public switched telephone network (PSTN) supports telephone calls between users. A telephone call from a first user to a second user requires the establishment of communication path from an originating switch that supports the first user to a terminating switch that supports the second user where the originating switch and the terminating switch are connected by one or more transmission networks. Each switch contains a set of interfaces that connects the switch to the transmission network.

FIG. 1 illustrates edge switches 10 and 12 connected to transmission networks 14 and 15. Edge switch 10 includes an interface 16 that supports communications over communication channels 18 and 20 to transmission network elements 22 and 24, respectively. Similarly, edge switch 12 includes an interface 26 that supports communications over communication channels 28 and 30 to transmission network elements 32 and 34, respectively. Transmission networks 14 and 15 include transmission elements 25 and 36, respectively, that are interconnected with elements 22, 24, 32 and 34. The interconnection of transmission elements among different transmission networks provides additional paths in the case of a failure and increases reliability. The edge switches may comprise 5ESS Switches from Lucent Technologies Inc.; the communication channels being high-speed optical trunk lines; the transmission network elements being interoffice switches such as 4ESS Switches from Lucent Technologies Inc.

The PSTN is designed to provide a highly reliable telecommunication fabric. Normally, the systems are configured so that no single point of failure can disrupt communications between any two connected elements, and as a further objective it is desirable that no single point of failure can cause a reduction of capacity between any two connected elements. Further, a network may be configured so that:

1. a single failure will not isolate or totally eliminate communications between A and B;

2. a single failure will not reduce the capacity of communications between A and B;

3. a single failure will not affect existing communications between A and B (will not kill stable calls).

The telecommunication architecture shown in FIG. 1 illustrates these principles. Edge switch 10 is connected by duplicate communication channels (18, 20) and duplicate transmission network elements (22, 24); similarly, edge switch 12 is supported by duplicate communication channels and transmission network elements. No single point of failure in one of the elements supporting the edge switch will cause a loss of communication between the edge switch and the transmission network 14. Preferably, each pair of the communication channels and the transmission network elements supporting each edge switch are designed with a capacity sufficient to support the entire capacity of the respective edge switch so that a single point of failure will not diminish the call handling capacity of the switch. In normal operation an individual call between two given edge switches utilizes only one of the two possible communication routes. For example, switch 10 could primarily utilize communication channel 18 and transmission network element 22 when sending traffic to switch 12. Communication channel 20 and transmission network element 24 represent backup spare capacity to be used should an outage occur in the other pair.

While active/standby duplex operation is one method of operation, it is not the only method. Active/active load-sharing is another method of providing duplex operation that allows the ongoing use of both interfaces while reserving 100% excess capacity. It should be noted there are different ways to use the excess capacity, but in these cases the excess capacity is 100% or two times the rated capacity is required. The interconnection among transmission networks 14 and 15 also enhances reliability in the case of a failure that would affect one transmission network.

Generally the “duplex capacity”architecture as represented in FIG. 1 has proved to be effective in providing a reliable telecommunication fabric. However, it also has certain disadvantages. The cost of the network increases significantly as the capacity of the network is increased. The concept of duplex capacity means that scaling an existing network to increase its capacity requires newly added elements to be duplicated to maintain reliability against a single point of failure event (that is, network elements equipped with 100% extra capacity). Since the additional reserved capacity cannot be used by the traffic carried by the switch, the cost of this backup capacity is incurred solely to ensure reliability. Also the cost of the interface ports required to support the redundant capacity becomes significant. Thus, there exists a need to provide a reliable telecommunication system that can be scaled to increase its capacity with a lower cost than is associated with duplex capacity.

### SUMMARY OF THE INVENTION

It is an object of the present invention to substantially overcome these disadvantages associated with telecommunications systems utilizing duplex sparing.

In an embodiment, a telecommunication system includes edge switches and a transmission system that interconnects the edge switches. The transmission system includes a plurality of layered transmission networks. Communication channels connect each edge switch to at least a first of the layered transmission networks.

In an exemplary method for routing traffic in a telecommunication system having ordered, layered transmission networks, the originating and terminating edge switches to carry a new requested traffic are identified. The highest order layered transmission network connecting the originating and terminating edge switches that is available to carry the traffic is determined. The determined highest order layered transmission network to carry the traffic is assigned to carry the traffic.

### BRIEF DESCRIPTION OF THE DRAWINGS

FIG. 1 illustrates a telecommunication system in accordance with the prior art in which duplex sparing is utilized.

FIG. 2 illustrates an embodiment of a telecommunication system in accordance with the present invention.

FIG. 3 is a flow diagram showing exemplary traffic routing in the embodiment of FIG. 2.

### DETAILED DESCRIPTION

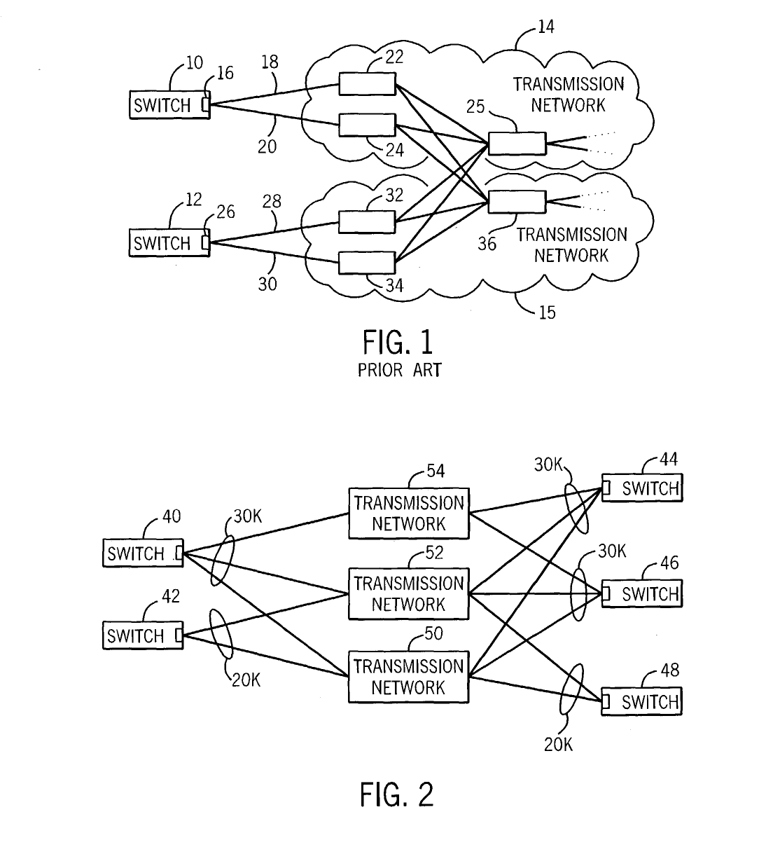

FIG. 2 illustrates embodiment of a system in accordance with the present invention that employs a layered architecture instead of the duplex architecture as shown in the system of FIG. 1. As used herein “layered”transmission networks means the use of transmission networks having connections to edge switches that are ordered and where each transmission network does not interconnect with other transmission networks. Before describing the specific details of the embodiment it will be helpful to more fully understand the differences between a layered architecture and a duplex architecture.

The concept of using layered transmission networks, as opposed to transmission networks with 100% reserve capacity as in FIG. 1, provides important advantages. In a layered architecture, 100% of the interfaces with the edge switches are concurrently usable. That is, all communication channels and the associated transmission networks for each switch can be concurrently used to handle the traffic load of the switch. This should be contrasted with the 100% reserved capacity architecture in which only 50% of the capacity is available; the other 50% is held in reserve and are not utilized except in the case of a failure or fault in the active interfaces.

Scalability of a layered architecture is improved. The number of layers of transmission networks can be large and is limited only by the number of switch connections that can be supported by each transmission network. In contrast, a duplex architecture is limited in size by the overhead of the interconnecting elements, with this limit being determined by the size of the smallest element in the fabric.

With layering, the costs associated with providing alternate paths in case of a failure in one path go down as the network gets larger. To accommodate such redundancy, each switch need connect to only one additional layer for N+1 sparing. The spare capacity is the total capacity divided by N where N is the number of layers required for traffic in a fault free state. In contrast, a switch in a duplex fabric must connect to two elements of a transmission network each with full capacity in order to maintain the full capacity of the switch in the case of the loss/failure of an element.

Capacity in a layered network can be divided across as many layers as necessary to support the required traffic throughput. Each layer (transmission network) in its simplest case could consist of a single node. The layers are ordered, but not hierarchically linked. All edge switches must connect to at least two layers where N+1 sparing is used and one of the connections is to the lowest (first) layer. Thus, the quantity of interfaces or ports on the first layer determines the number of switches that can connect to the network. In contrast, the size of a duplex network is limited by the number of interfaces on each node since half of the interfaces must be allocated for sparing connections. The maximum number of nodes is equal to one-half the number of interfaces on node. When more than 50% of the number of interfaces on a node is required for connections to other elements or switches, the size of the node must be increased.

In a duplex fabric, that provides reliability such that no single point of failure causes a loss of capacity between any two edge nodes, interconnections are made between the nodes of the transmission networks. The nodes in each layer of a layered network do not require additional connections to other nodes outside the transmission network to maintain reliability; the reliability is provided by the use of an extra layer (N+1).

In FIG. 2, edge switches 40, 42, 44, 46 and 48 are each connected by a respective interface and communication channels to the group of layered transmission networks. The number associated with the line encircling the communication channels for each switch represents the switch capacity in equivalent DS0 (DS zero) lines. Thus, the capacities of switches 40, 42, 44, 46 and 48 are 30 k, 20 k, 30 k, 30 k and 20 k, respectively; where “k” represents 1000. Thus, the total capacity of all the illustrated edge switches is 130,000 equivalent DS0 lines. Switch 40 is connected by three communication channels to transmission networks 50, 52 and 54. Switch 42 is connected by two communication channels to transmission networks 50 and 52. Switch 44 is connected by three communication channels to transmission networks 50, 52 and 54. Switch 46 is also connected by three communication channels to transmission networks 50, 52 and 54. Switch 48 is connected by two communications channels to transmission networks 50 and 52.

The three transmission networks in FIG. 2 represent an N+1 sparing. The value of N is determined per edge switch and is the number of transmission networks the edge switch connects to minus one. Assuming each transmission network will proportionally share the traffic load and that N+1 sparing is employed, the loss of one transmission network should leave the network capable of handling the required capacity of 80 k, i.e. sum of X_{[40-48]}*(Y−1)/Y or Σⁱ⁼⁴⁸ᵢ₌₄₀(Xᵢ*(Yᵢ−1/Yᵢ)), where X represents the total connection capacity of each edge switch and Y represents the total number of transmission networks to which the edge switch is connected. X values are 30 k, 20 k, 30 k, 30 k, 20 k and corresponding values of Y are 3, 2, 3, 3, 2. A failure of any one of the transmission networks will reduce the capacity of the remaining two transmission networks to a total capacity of at least 80 k which is still equal to the total required capacity of all of the edge switches. Thus, the failure of any one of the transmission networks or a communication channel between a transmission network and an edge switch will not reduce the call handling capacity of the total transmission network below the total required capacity of all edge switches.

Each of the edge switches have one communication channel connected to the lowest order transmission network 50. Even if the capacity of a switch could be fully supported by a single communication channel connected to transmission network 50, the switch would utilize another communication channel connected to another transmission network, preferably the transmission network next in order, i.e. transmission network 52. This is to provide the “+1” sparing to provide additional redundancy in the case of a failure. Depending on the capacity of the transmission networks and the transmission capacity of the communication channels, it may be necessary or desirable to connect an edge switch to more than two transmission networks. In general, the larger the capacity of the switch, the more likely and/or desirable it will be to utilize more than two communication channels connected to more than two transmission networks. For example, in the illustrative embodiment, edge switches 40, 44 and 46 each have a 30 k equivalent DS0 capacity and are supported by three communication channels connected to transmission networks 50, 52 and 54, respectively. Edge switches 42 and 48 each have 20 k capacity and are supported by two sets of communication channels and transmission networks. The number of communication channel/transmission network sets that supports a switch may be made based on whether the switch is anticipated to carry a substantially higher average traffic load than other switches, the bandwidth of the communication channels available to switch is less than the bandwidth of the communication channels available to other switches, or because it is anticipated that a substantial portion of the traffic of the switch will be associated with a particular other switch.

In addition to these factors, the unit cost of port interfaces, the incremental cost of adding another communication channel, and the costs associated with adding another transmission network are all considerations to be weighed in determining the number of additional transmission networks to be used, beyond the required two transmission networks needed for N+1 capability.

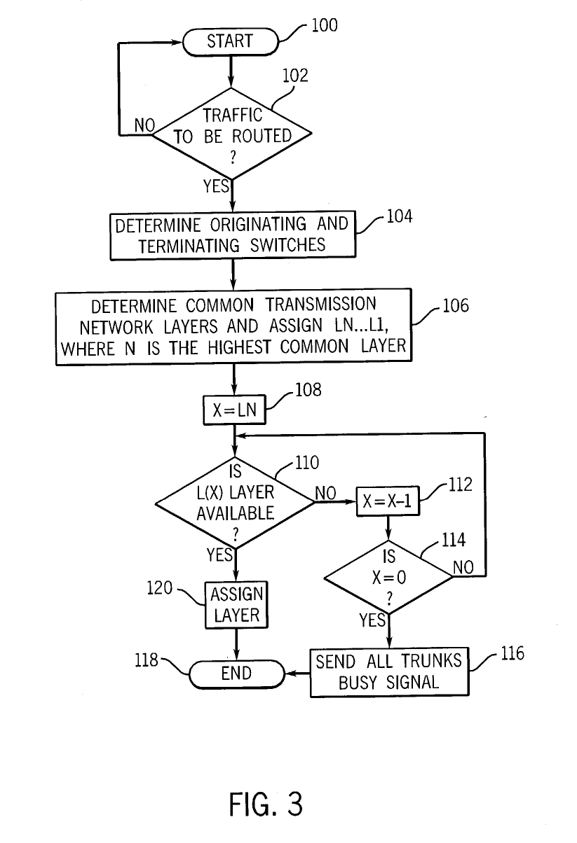

FIG. 3 is a flow diagram illustrating a method in accordance with the present invention for selecting a path through a layered telecommunication network such as shown in FIG. 2. The method begins at START 100. A determination is made in step 102 of whether traffic is to be routed in the subject network. A NO determination results in a return to the beginning of step 102 to await traffic to be routed. A YES determination causes step 104 to determine the originating and terminating switches associated with the traffic to be routed. In step 106 a determination is made of the common transmission network layers between the originating and terminating switches. The common layers are assigned L(n) . . . L(1), where n is the highest common layer. In step 108, variable X is assigned to be equal to L(n). In step 110 a determination is made of whether the layer L(X) is available. A NO determination results in step 112 causing variable X to be decremented as X−1. In step 114 a determination is made of whether variable X is equal to zero. A NO determination results in a return to the beginning of step 110 in which a determination will be made of whether the next incremented lower layer is available. A YES determination by step 114 results in step 116 sending an all trunks busy signal indicating that a communication path is not available through any of the common layers. The method will then conclude at END 118. A YES determination at step 110 results in the layer determined to be available being assigned at step 120. The method then concludes at END 118.

The method of FIG. 3 assigns a call path to the highest common transmission network that is available between the originating and terminating switches. This effectively reserves the lower layers for traffic that cannot physically be offered to the higher layers. In accordance with a preferred embodiment, each of the switches is connected to the lowest transmission network layer and hence it is desired to route traffic to higher layers in order to ensure that sufficient traffic handling capability exists at the lowest layer. In the special case where all edge nodes are connected to all transmission network layers by substantially the same bandwidth communication channels, path hunting can start with any layer and progress in a round robin fashion; in this case it may be desirable to rotate the starting layer or assign a random starting layer if traffic loading among the transmission networks is desired.

Various changes and substitutions to the exemplary embodiments can be made by those skilled in the art without departing from the scope of the present invention. For example, each edge switch need not be connected to a minimum of two transmission networks if N+1 sparing is not utilized. If each edge switch is connected to each transmission network layer, there is no “lowest” layer since all layers have equal connectivity to the edge switches. The number of transmission networks will typically be determined based on the individual switch capacity, total capacity of all switches, anticipated traffic loading among switches, and bandwidth of available communication channels. Network elements, such as routers, etc., could be substituted for the switches of FIG. 2 and supported by the transmission networks. Further, the transmission networks may all be employed within one system or within one large network element. Although embodiments of the present invention have been described above and shown in the drawings, the scope of the invention is defined by the claims that follow.

We claim:

1. A telecommunication system comprising:
edge switches;
a transmission system that interconnects said edge switches, said transmission system comprising at least three layered independent transmission networks;
communication channels connecting each edge switch to at least a first of the layered transmission networks.

2. The system of claim 1 wherein each edge switch is also connected to a second of the layered transmission networks.

3. The system of claim 1 wherein said transmission system consists of only layered transmission networks.

4. The system of claim 1 wherein all of said communication channels are concurrently used to carry traffic for an associated edge switch.

5. The system of claim 1 wherein said transmission networks are sized so that a failure of any one of said transmission networks will not cause a reduction in total traffic being carried by the transmission system.

6. The system of claim 1 wherein said edge switches comprise end office switches serving the public switched telephone network.

7. A method for routing traffic in a telecommunication system having ordered, layered transmission networks comprising the steps of:
identifying the originating and terminating edge switches to carry a new requested traffic;
determining the highest order layered transmission network connecting the originating and terminating edge switches that is available to carry the traffic;
assigning said highest order layered transmission network to carry the traffic.

8. The method according to claim 7 wherein said determining step comprises:
determining all layered transmission networks that connect the originating and terminating edge switches;
sequentially determining the availability of the layered transmission networks that connect the originating and terminating edge switches starting at the highest ordered layered transmission network and continuing said sequential determining by decreasing order;
ceasing said sequential determination upon finding one of the layered transmission networks available to carry said traffic.

9. A telecommunication system comprising:
edge network elements;
a transmission system that interconnects said edge network elements, said transmission system comprising at least three layered independent transmission networks;
communication channels connecting each edge network element to at least a first of the layered transmission networks.

10. The system of claim 9 wherein each edge network element is also connected to a second of the layered transmission networks.

11. The system of claim 9 wherein said transmission system consists of only layered transmission networks.

12. The system of claim 9 wherein all of said communication channels are concurrently used to carry traffic for an associated edge network element.

13. The system of claim 9 wherein said transmission networks are sized so that a failure of any one of said transmission networks will not cause a reduction in total traffic being carried by the transmission system.

14. The system of claim 9 wherein said edge network elements comprise end office network elements serving the public switched telephone network.
